(19) United States
(12) Patent Application Publication
(10) Pub. No.: US 2025/0267715 A1
(43) Pub. Date: Aug. 21, 2025

(54) CHANNEL TRANSMISSION METHOD AND APPARATUS, AND STORAGE MEDIUM

(71) Applicant: Beijing Xiaomi Mobile Software Co., Ltd., Beijing (CN)

(72) Inventor: Yajun ZHU, Beijing (CN)

(73) Assignee: Beijing Xiaomi Mobile Software Co., Ltd., Beijing (CN)

(21) Appl. No.: 18/859,370

(22) PCT Filed: Apr. 25, 2022
(86) PCT No.: PCT/CN2022/089096

§ 371 Date: Oct. 23, 2024

(51) Int. Cl. H04W 74/0833; H04W 74/00

(52) U.S. Cl. CPC H04W 74/0833; H04W 74/006

(57) ABSTRACT

A channel transmission method. The method includes: determining, based on indication information transmitted by a base station, a target repetition number corresponding to a polarization adopted by the terminal; and transmitting, in accordance with the target repetition number, a physical random access channel (PRACH) on one or more random access resources.

### CROSS-REFERENCE TO RELATED APPLICATION

This application is the U.S. national phase application of International Application No. PCT/CN2022/089096, filed on Apr. 25, 2022, the disclosure of which is incorporated herein by reference in its entirety for all purposes.

### TECHNICAL FIELD

The present disclosure relates to the field of communications, and in particular, to channel transmission methods, channel transmission apparatuses, and storage media.

### BACKGROUND

In a non-terrestrial network (NTN), antennas on satellites are mostly circularly polarized, while terminals on the ground may use circularly polarized antennas or linearly polarized antennas depending on their categories. A polarization loss occurs when there is a polarization mismatch between a base station antenna and a terminal antenna. The polarization loss may be compensated for by multiple repeated transmissions (i.e., repetitions).

When repeatedly transmitting a physical random access channel (PRACH), for a ground terminal repetition scheme, which refers to re-transmitting a preamble if no feedback (which may be message 2 or message 4 in a random access procedure) is received from the base station within a period, it will reduce the efficiency due to a long round-trip time (RTT) in the NTN.

If a repetition scheme for a narrow band Internet of Things (NB-IoT) physical random access channel (NPRACH) is reused, multiple repetitions of the preamble are not actually required by the covered terminals in the NTN for a case of the same polarization, for example a case where the polarization of the satellite is identical to that of the terminal. Therefore, it will lead to a resource waste and a terminal power consumption if a repetition number is configured for all the terminals.

### SUMMARY

In view of the above, examples of the present disclosure provide a channel transmission method and apparatus, and a storage medium.

According to a first aspect of the examples of the present disclosure, a channel transmission method is provided. The method is performed by a terminal and includes: determining, based on indication information transmitted by a base station, a target repetition number corresponding to a polarization adopted by the terminal; and transmitting, in accordance with the target repetition number, a physical random access channel (PRACH) on one or more random access resources.

According to a second aspect of the examples of the present disclosure, a channel transmission method is provided. The method is performed by a base station and includes: transmitting indication information to a terminal, wherein the indication information is used by the terminal to determine a target repetition number corresponding to a polarization adopted by the terminal; and receiving, on one or more random access resources, a PRACH that is transmitted by the terminal in accordance with the target repetition number.

According to a third aspect of the examples of the present disclosure, a channel transmission apparatus is provided, including: one or more processors; and one or more memories for storing instructions executable by the one or more processors. The one or more processors are configured to: determine, based on indication information transmitted by a base station, a target repetition number corresponding to a polarization adopted by the terminal; and transmit, in accordance with the target repetition number, a PRACH on one or more random access resources.

The technical solutions provided by the examples of the present disclosure may obtain the following beneficial effects.

In the examples of the present disclosure, the terminal may determine the target repetition number corresponding to the polarization adopted by the terminal based on the indication information transmitted by the base station, and transmit the PRACH on the one or more random access resources in accordance with the target repetition number. By means of the present disclosure, the corresponding target repetition number of the PRACH can be determined for the terminal with a distinct polarization, thereby effectively compensating the terminal that has a polarization loss for the polarization loss, and effectively reducing a terminal power loss for the terminal that has no polarization loss, which has a high availability.

It is to be understood that the foregoing general description and the following detailed description are exemplary and explanatory only and are not restrictive of the present disclosure.

### BRIEF DESCRIPTION OF THE DRAWINGS

The accompanying drawings, which are incorporated in and constitute a part of the description, illustrate examples consistent with the present disclosure and, together with the description, serve to explain the principles of the disclosure.

FIG. 1 illustrates a schematic flowchart of a channel transmission method according to an example.

FIG. 2 illustrates a schematic flowchart of another channel transmission method according to an example.

FIG. 3A illustrates a schematic flowchart of another channel transmission method according to an example.

FIG. 3B illustrates a schematic flowchart of another channel transmission method according to an example.

FIG. 4 illustrates a schematic flowchart of another channel transmission method according to an example.

FIG. 5A illustrates a schematic flowchart of another channel transmission method according to an example.

FIG. 5B illustrates a schematic flowchart of another channel transmission method according to an example.

FIG. 5C illustrates a schematic flowchart of another channel transmission method according to an example.

FIG. 6 illustrates a schematic flowchart of another channel transmission method according to an example.

FIG. 7A illustrates a schematic diagram of transmitting a preamble in accordance with a target repetition number according to an example.

FIG. 7B illustrates a schematic diagram of transmitting a preamble in accordance with a target repetition number according to an example.

FIG. 8 illustrates a schematic flowchart of another channel transmission method according to an example.

FIG. 9 illustrates a schematic flowchart of another channel transmission method according to an example.

FIG. 10A illustrates a schematic flowchart of another channel transmission method according to an example.

FIG. 10B illustrates a schematic flowchart of another channel transmission method according to an example.

FIG. 11 illustrates a schematic flowchart of another channel transmission method according to an example.

FIG. 12A illustrates a schematic flowchart of another channel transmission method according to an example.

FIG. 12B illustrates a schematic flowchart of another channel transmission method according to an example.

FIG. 12C illustrates a schematic flowchart of another channel transmission method according to an example.

FIG. 13 illustrates a schematic flowchart of another channel transmission method according to an example.

FIG. 14 illustrates a block diagram of a channel transmission apparatus according to an example.

FIG. 15 illustrates a block diagram of another channel transmission apparatus according to an example.

FIG. 16 illustrates a schematic structural diagram of a channel transmission apparatus according to an example of the present disclosure.

FIG. 17 illustrates a schematic structural diagram of another channel transmission apparatus according to an example of the present disclosure.

### DETAILED DESCRIPTION OF THE EMBODIMENTS

Examples will be described in detail here with the illustrations thereof illustrated in the drawings. When the following descriptions involve the drawings, like numerals in different drawings refer to like or similar elements unless otherwise indicated. The implementations described in the following examples do not represent all implementations consistent with the present disclosure. Rather, they are merely examples of apparatuses and methods consistent with some aspects of the present disclosure as detailed in the appended claims.

The terms used in the present disclosure are for the purpose of describing particular examples only, and are not intended to limit the present disclosure. Terms determined by “a”, “said” and “the” in their singular forms in the present disclosure and the appended claims are also intended to include their plural forms, unless clearly indicated otherwise in the context. It is also to be understood that the term “and/or” as used herein is and includes any or all possible combinations of at least one associated listed item.

It is to be understood that, although terms “first,” “second,” “third,” and the like may be used in the present disclosure to describe various information, such information should not be limited to these terms. These terms are only used to distinguish the information of the same type with each other. For example, without departing from the scope of the present disclosure, first information may be referred as second information; and similarly, second information may also be referred as first information. Depending on the context, the word “if” as used herein may be interpreted as “when”, “upon”, or “in response to determining”.

The following first introduces the channel transmission methods provided by the present disclosure from the terminal side.

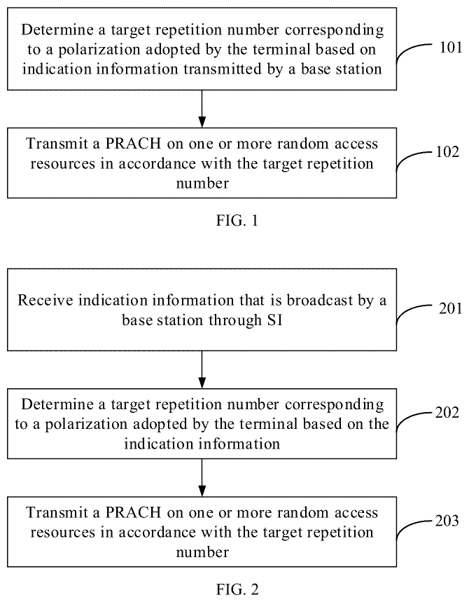

The examples of the present disclosure provide a channel transmission method. As illustrated in FIG. 1, it illustrates a flowchart of a channel transmission method according to an example, and may be applied to a terminal, which may be a terminal in a non-terrestrial network (NTN). The method may include the following steps 101-102.

At step 101, a target repetition number corresponding to a polarization adopted by the terminal is determined based on indication information transmitted by a base station.

At step 102, a physical random access channel (PRACH) is transmitted on one or more random access resources in accordance with the target repetition number.

In the example of the present disclosure, the one or more random access resources are pre-allocated to the terminal by the base station and used for the terminal to perform a random access procedure.

In the example, the corresponding target repetition number of the PRACH can be determined for the terminal with a distinct polarization, thereby effectively compensating the terminal that has a polarization loss for the polarization loss, and effectively reducing a terminal power loss for the terminal that has no polarization loss, which has a high availability.

In some alternative or additional examples, as illustrates in FIG. 2, it illustrates a flowchart of a channel transmission method according to an example. The method may be applied to a terminal, which may be a terminal in an NTN. The method may include the following steps 201-203.

At step 201, indication information that is broadcast by a base station through system information (SI) is received.

In the example of the present disclosure, the terminal has not accessed the base station and is to complete an initial random access procedure based on the SI.

At step 202, a target repetition number corresponding to a polarization adopted by the terminal is determined based on the indication information.

At step 203, a PRACH is transmitted on one or more random access resources in accordance with the target repetition number.

In the example, the base station may broadcast the indication information through the SI, and the terminal that is to complete the initial random access procedure may read the indication information from the SI, and may further determine the target repetition number based on the indication information, so as to transmit the PRACH in accordance with the target repetition number. Therefore, the corresponding target repetition number of the PRACH can be determined for the terminal with a distinct polarization, thereby effectively compensating the terminal that has a polarization loss for the polarization loss, and effectively reducing a terminal power loss for the terminal that has no polarization loss, which has a high availability.

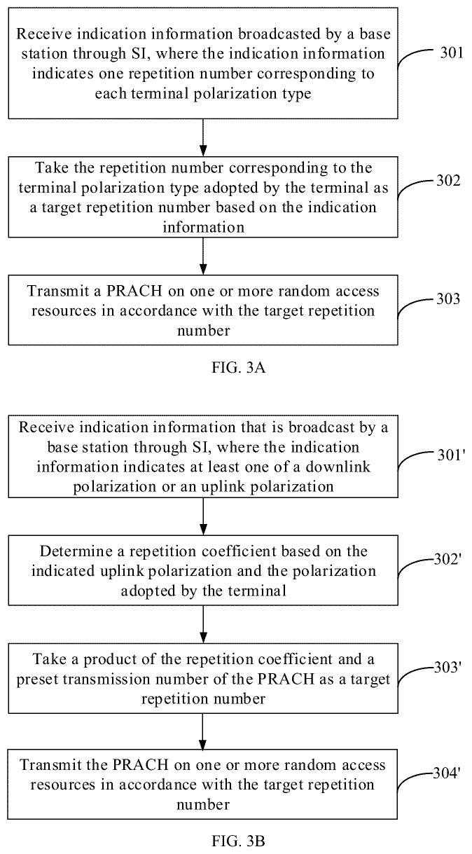

In some alternative or additional examples, as illustrates in FIG. 3A, it illustrates a flowchart of a channel transmission method according to an example. The method may be applied to a terminal, which may be a terminal in an NTN. The method may include the following steps 301-303.

At step 301, indication information broadcasted by a base station through SI is received, where the indication information indicates one repetition number corresponding to each terminal polarization type.

In the example of the present disclosure, the terminal has not accessed the base station and is to complete an initial random access procedure based on the SI.

In the example of the present disclosure, one or more candidate repetition numbers corresponding to each terminal polarization type may be agreed upon by a protocol. The terminal polarization types include, but are not limited to, a circular polarization, a linear polarization, supporting both the circular polarization and the linear polarization, etc. The candidate repetition numbers corresponding to the terminal polarization types are shown as Table 1.

TABLE 1

| Terminal polarization type | Candidate repetition number |
|---|---|
| Circular polarization | 1, 2, 3, . . . |
| Linear polarization | 2, 4, 6, . . . |
| Supporting both circular polarization | 1 |
| and linear polarization | |

The circular polarization includes, but is not limited to, a right-hand circularized polarization (RHCP) and a left-hand circularized polarization (LHCP).

In the example of the present disclosure, the base station may determine one repetition number corresponding to each terminal polarization type according to Table 1. For example, the repetition number corresponding to the circular polarization is 1, the repetition number corresponding to the linear polarization is 2, and the repetition number corresponding to supporting both the circular polarization and the linear polarization is 1. The base station takes one repetition number corresponding to each terminal polarization type as the indication information and broadcasts it through the SI. The terminal may obtain the indication information via receiving the SI.

At step 302, the repetition number corresponding to the terminal polarization type adopted by the terminal is taken as a target repetition number based on the indication information.

In the example of the present disclosure, assuming that the polarization adopted by the terminal is the RHCP, the corresponding terminal polarization type is the circular polarization, and the terminal may take the repetition number corresponding to the circular polarization in the indication information, 1, as the target repetition number.

At step 303, a PRACH is transmitted on one or more random access resources in accordance with the target repetition number.

In the example, it is achieved that the terminal determines the target repetition number for transmitting the PRACH based on the indication information in the SI, and can determine the corresponding target repetition number of the PRACH for the terminal with a distinct polarization, thereby effectively compensating the terminal that has a polarization loss for the polarization loss, and effectively reducing a terminal power loss for the terminal that has no polarization loss, which has a high availability.

In some alternative or additional examples, as illustrates in FIG. 3B, it illustrates a flowchart of a channel transmission method according to an example. The method may be applied to a terminal, which may be a terminal in an NTN. The method may include the following steps 301′-304′.

At step 301′, indication information that is broadcast by a base station through SI is received, where the indication information indicates at least one of a downlink polarization or an uplink polarization.

In the example of the present disclosure, the terminal has not accessed the base station and is to complete an initial random access procedure based on the SI.

In the example of the present disclosure, the downlink polarization refers to a polarization adopted by the base station to transmit downlink signals, while the uplink polarization refers to a polarization adopted to transmit uplink signals, which may be the polarization adopted by the terminal to transmit the uplink signals and expected by the base station.

At step 302′, a repetition coefficient is determined based on the indicated uplink polarization and the polarization adopted by the terminal.

In a possible implementation, in a case that the indication information indicates at least the uplink polarization, it is determined that the terminal has no polarization loss when the uplink polarization indicated by the indication information is identical to the polarization adopted by the terminal, and the repetition coefficient may be determined to be 1, thereby avoiding a terminal power consumption and a terminal resource waste due to multiple repetitions of the PRACH.

For example, the uplink polarization is the RHCP and the polarization adopted by the terminal is also the RHCP. Thus, the repetition coefficient is determined to be 1.

In another possible implementation, in a case that the indication information indicates at least the uplink polarization, it is determined that the terminal has a polarization loss when the uplink polarization indicated by the indication information is different from the polarization adopted by the terminal, and the repetition coefficient is determined to be 2, thereby compensating for the polarization loss via multiple repetitions of the PRACH.

For example, the uplink polarization is the RHCP and the polarization adopted by the terminal is the linear polarization. Thus, the repetition coefficient is determined to be 2.

In another possible implementation, in a case that the indication information indicates only the downlink polarization, that is, only the downlink polarization is indicated by the indication information, the terminal may determine that the uplink polarization indicated by the indication information is identical to the downlink polarization indicated by the indication information. Furthermore, the terminal may determine the repetition coefficient in the above way based on whether the uplink polarization indicated by the indication information is identical to the polarization of the terminal.

For example, the indication information indicates that the downlink polarization is the LHCP, and then the terminal considers that the uplink polarization indicated by the indication information is also the LHCP.

At step 303′, a product of the repetition coefficient and a preset transmission number of the PRACH is taken as a target repetition number.

In the example of the present disclosure, the preset transmission number of the PRACH may be agreed upon by a protocol or configured by the base station. Assuming that the preset transmission number of the PRACH is N, the terminal may take the product of the repetition coefficient and N as the target repetition number.

For example, the repetition coefficient is 2 and thus the target repetition number is 2N, and the repetition coefficient is 1 and thus the target repetition number is N.

In a possible implementation, the terminal may consider N to be 1 by default if the preset transmission number is not configured by the base station.

At step 304′, the PRACH is transmitted on one or more random access resources in accordance with the target repetition number.

In the example, it is achieved that the terminal determines the target repetition number for transmitting the PRACH based on the indication information in the SI, thereby effectively compensating the terminal that has a polarization loss for the polarization loss, and effectively reducing a terminal power consumption and avoiding a terminal resource waste for the terminal that has no polarization loss, which has a high availability.

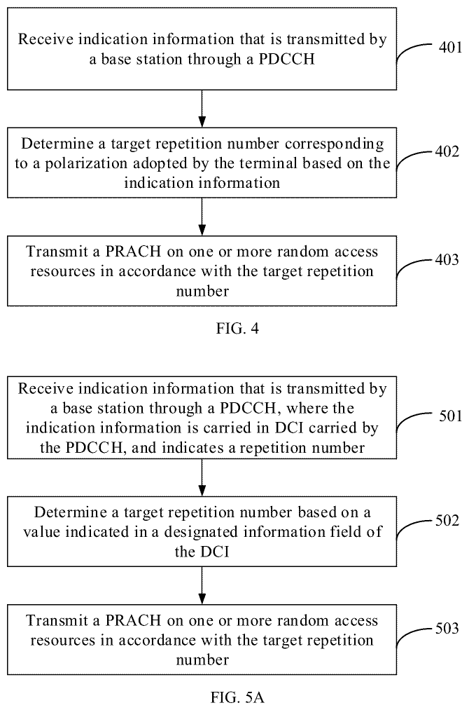

In some alternative or additional examples, as illustrates in FIG. 4, it illustrates a flowchart of a channel transmission method according to an example. The method may be applied to a terminal, which may be a terminal in an NTN. The method may include the following steps 401-403.

At step 401, indication information that is transmitted by a base station through a physical downlink control channel (PDCCH) is received.

In the example of the present disclosure, a random access procedure may also be triggered based on a PDCCH order. In this case, the terminal may receive the indication information transmitted by the base station through the PDCCH.

At step 402, a target repetition number corresponding to a polarization adopted by the terminal is determined based on the indication information.

At step 403, a PRACH is transmitted on one or more random access resources in accordance with the target repetition number.

In the example, it is achieved that the terminal determines the target repetition number for transmitting the PRACH based on the indication information in the PDCCH, thereby effectively compensating the terminal that has a polarization loss for the polarization loss, and effectively reducing a terminal power consumption and avoiding a terminal resource waste for the terminal that has no polarization loss, which has a high availability.

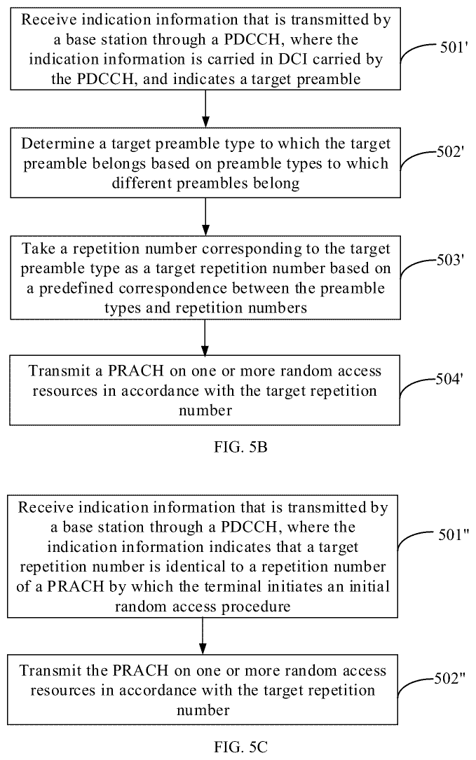

In some alternative or additional examples, as illustrates in FIG. 5A, it illustrates a flowchart of a channel transmission method according to an example. The method may be applied to a terminal, which may be a terminal in an NTN. The method may include the following steps 501-503.

At step 501, indication information that is transmitted by a base station through a PDCCH is received, where the indication information is carried in downlink control information (DCI) carried by the PDCCH, and indicates a repetition number.

At step 502, a target repetition number is determined based on a value indicated in a designated information field of the DCI.

In a possible implementation, the designated information field may be an information field newly added in the DCI, which is specifically configured to indicate the repetition number.

In another possible implementation, the designated information field may reuse an existing information field of the DCI. In some examples, an information field corresponding to a preamble index may be reused.

The above are only the examples for description. In practical applications, the designated information field may reuse another information field of the DCI, which is not limited in the present disclosure.

In the example of the present disclosure, the base station indicates the repetition number through the DCI's display, and the terminal may determine the value indicated by the designated information field and directly take the value as the target repetition number.

At step 503, a PRACH is transmitted on one or more random access resources in accordance with the target repetition number.

In the example, it is achieved that the terminal determines the target repetition number for transmitting the PRACH based on the indication information carried in the DCI of the PDCCH, thereby effectively compensating the terminal that has a polarization loss for the polarization loss, and effectively reducing a terminal power consumption and avoiding a terminal resource waste for the terminal that has no polarization loss, which has a high availability.

In some alternative or additional examples, as illustrates in FIG. 5B, it illustrates a flowchart of a channel transmission method according to an example. The method may be applied to a terminal, which may be a terminal in an NTN. The method may include the following steps 501′-504′.

At step 501′, indication information that is transmitted by a base station through a PDCCH is received, where the indication information is carried in DCI carried by the PDCCH, and indicates a target preamble.

In the example of the present disclosure, the DCI carries the indication information, and the indication information is the target preamble indicated by the base station to the terminal.

At step 502′, a target preamble type to which the target preamble belongs is determined based on preamble types to which different preambles belong.

In a possible implementation, the terminal may determine the target preamble type to which the target preamble belongs based on the preamble types to which the different preambles belong. The base station may indicate the preamble types to which the different preambles belong through radio resource control (RRC) signaling.

For example, the base station indicates through the RRC signaling that Preamble #1 to Preamble #10 belong to a first preamble type, Preamble #11 to Preamble #20 belong to a second preamble type, and so on. When the target preamble carried in the DCI is Preamble #1, the target preamble type is the first preamble type.

At step 503′, a repetition number corresponding to the target preamble type is taken as a target repetition number based on a predefined correspondence between the preamble types and repetition numbers.

In the example of the present disclosure, the correspondence between the preamble types and the repetition numbers may be predefined by a protocol. For example, the repetition number corresponding to the first preamble type is 1, the repetition number corresponding to the second preamble type is 2, and so on. Assuming that the target preamble type is the first preamble type, the target repetition number is 1.

That is, the base station may implicitly indicate the repetition number through the DCI, and the terminal determines the target repetition number in the above way.

At step 504′, a PRACH is transmitted on one or more random access resources in accordance with the target repetition number.

In the example, it is achieved that the terminal determines the target repetition number for transmitting the PRACH based on the indication information carried in the DCI of the PDCCH, thereby effectively compensating the terminal that has a polarization loss for the polarization loss, and effectively reducing a terminal power consumption and avoiding a terminal resource waste for the terminal that has no polarization loss, which has a high availability.

In some alternative or additional examples, as illustrates in FIG. 5C, it illustrates a flowchart of a channel transmission method according to an example. The method may be applied to a terminal, which may be a terminal in an NTN. The method may include the following steps 501″-502″.

At step 501″, indication information that is transmitted by a base station through a PDCCH is received, where the indication information indicates that a target repetition number is identical to a repetition number of a PRACH by which the terminal initiates an initial random access procedure.

In the example of the present disclosure, when the terminal initiates the initial random access procedure, the approach of determining the repetition number of the PRACH is similar to the example illustrated in FIG. 3A or FIG. 3B, which is not repeated here. The base station may directly transmit the indication information to the terminal through a PDCCH, and inform the terminal via the indication information that the target repetition number is identical to the repetition number of the PRACH by which the terminal initiates the initial random access procedure.

For example, a repetition coefficient of the PRACH during the initial random access procedure is 2, and then a target repetition coefficient is 2.

At step 502″, the PRACH is transmitted on one or more random access resources in accordance with the target repetition number.

In the example, it is achieved that the terminal determines the target repetition number for transmitting the PRACH based on the indication information in the PDCCH, thereby effectively compensating the terminal that has a polarization loss for the polarization loss, and effectively reducing a terminal power consumption and avoiding a terminal resource waste for the terminal that has no polarization loss, which has a high availability.

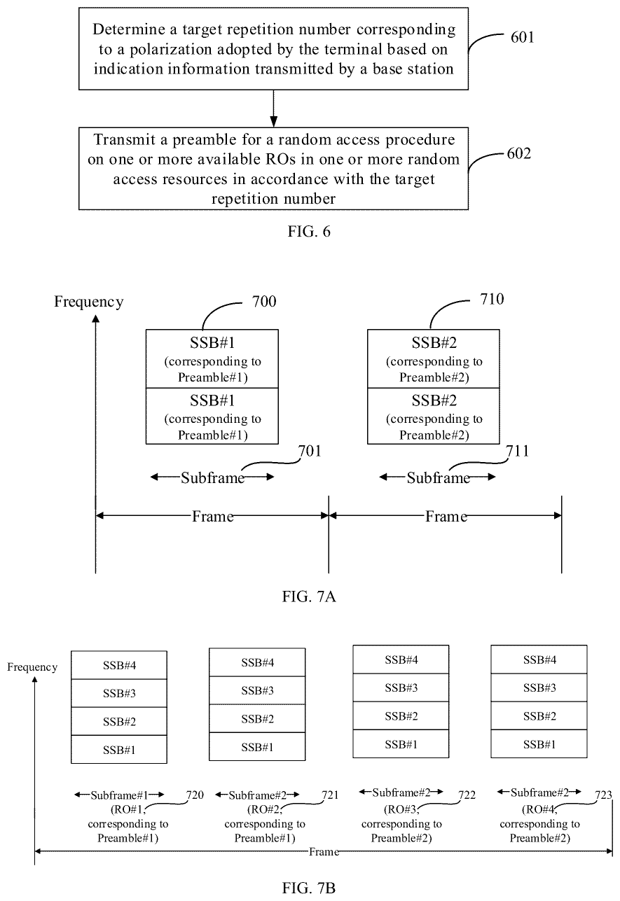

In some alternative or additional examples, as illustrates in FIG. 6, it illustrates a flowchart of a channel transmission method according to an example. The method may be applied to a terminal, which may be a terminal in an NTN. The method may include the following steps 601-602.

At step 601, a target repetition number corresponding to a polarization adopted by the terminal is determined based on indication information transmitted by a base station.

The approach for determining the target repetition number is similar to that provided in the described examples, which is not repeated here.

At step 602, a preamble for a random access procedure is transmitted on one or more available random access occasions (which are also called PRACH occasions, ROs) in one or more random access resources in accordance with the target repetition number.

In a possible implementation, the preamble may be transmitted on one or more available ROs in a frequency domain in accordance with the target repetition number.

For example, as illustrated in FIG. 7A, assuming that the target repetition number is 2, a PRACH configuration period is 1 frame of 10 milliseconds, and there is only one RO in each frame, the terminal repeatedly transmits the same preamble twice on different available ROs in a same subframe. Shown in the example are SSB #1 700 transmitted twice in a first subframe 701 and SSB #2 710, transmitted twice in a second subframe 711.

In another possible implementation, the preamble may be transmitted on one or more available ROs in a time domain in accordance with the target repetition number.

For example, as illustrated in FIG. 7B, assuming that the target repetition number is 2, the PRACH configuration period is 1 frame of 10 milliseconds, and there are four ROs in each frame, RO #1 720, RO #2 721, RO #3 722, and RO #4 723, the terminal may transmit the same preamble on two consecutive available ROs in one frame. The two consecutive available ROs may be consecutive or nonconsecutive subframes, which are not limited in the present disclosure.

In the example, it is achieved that the terminal determines the target repetition number for transmitting the PRACH based on the indication information transmitted by the base station. Furthermore, the terminal transmits the preamble to the base station on the available RO(s). Therefore, it can effectively compensate the terminal having a polarization loss for the polarization loss, and effectively reduce a terminal power consumption and avoid a terminal resource waste for the terminal having no polarization loss, which has a high availability.

It is to be noted that in the examples of the present disclosure, the target repetition number is the number of times the terminal transmits the PRACH. When the target repetition number is 1, the terminal is to actually transmit the PRACH once. If the target repetition number is greater than 1, the terminal is to repeated transmit the PRACH for multiple times.

In the examples of the present disclosure, when the target repetition number is determined to be 1 in the described way, the terminal that has no polarization loss is to transmit the PRACH to the base station only once, thereby avoiding the terminal energy loss and the signaling resource waste caused by the situation where all terminals are configured to repeatedly transmit the PRACH for multiple times.

When the target repetition number is determined to be greater than 1 in the described way, the terminal that has the polarization loss is effectively compensated for the polarization loss by repeatedly transmitting the PRACH for multiple times. Next, the following introduces the channel transmission methods provided by the present disclosure from a base station side.

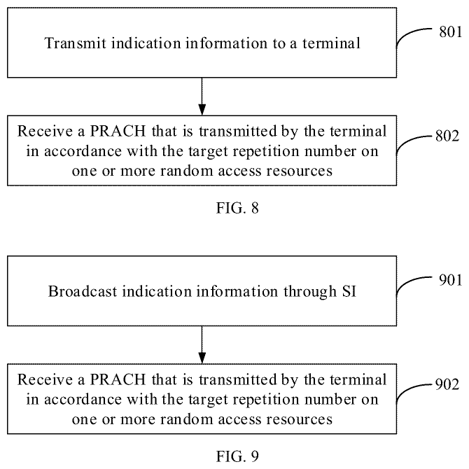

The examples of the present disclosure provide a channel transmission method. As illustrated in FIG. 8, it illustrates a flowchart of a channel transmission method according to an example, and may be applied to a base station, which may be a base station in an NTN. The method may include the following steps 801-802.

At step 801, indication information is transmitted to a terminal.

In the example of the present disclosure, the indication information is used by the terminal to determine a target repetition number corresponding to a polarization adopted by the terminal.

At step 802, a PRACH that is transmitted by the terminal in accordance with the target repetition number is received on one or more random access resources.

In the example, the base station may transmit the indication information to the terminal, so that the terminal determines the target repetition number corresponding to the polarization adopted by itself. And the base station receives the PRACH transmitted by the terminal in accordance with the target repetition number on the one or more random access resources. By means of the present disclosure, the corresponding target repetition number of the PRACH can be determined for the terminal with a distinct polarization, thereby effectively compensating the terminal that has a polarization loss for the polarization loss, and effectively reducing a terminal power loss for the terminal that has no polarization loss, which has a high availability.

In some alternative or additional examples, as illustrates in FIG. 9, it illustrates a flowchart of a channel transmission method according to an example. The method may be applied to a base station, which may be a base station in an NTN. The method may include the following steps 901-902.

At step 901, indication information is broadcast through SI.

In the example of the present disclosure, the indication information is used by the terminal to determine a target repetition number corresponding to a polarization adopted by the terminal.

At step 902, a PRACH that is transmitted by the terminal in accordance with the target repetition number is received on one or more random access resources.

In the example of the present disclosure, the terminal has not accessed the base station and is to complete an initial random access procedure based on the SI.

In the example, the base station may broadcast the indication information through the SI, so that the terminal may determine the target repetition number based on the indication information, and then transmit the PRACH in accordance with the target repetition number. Therefore, the corresponding target repetition number of the PRACH may be determined for the terminal with a distinct polarization, thereby it is achieved that the terminal having a polarization loss is effectively compensated for the polarization loss, and a terminal power loss is effectively reduced for the terminal having no polarization loss, which has a high availability.

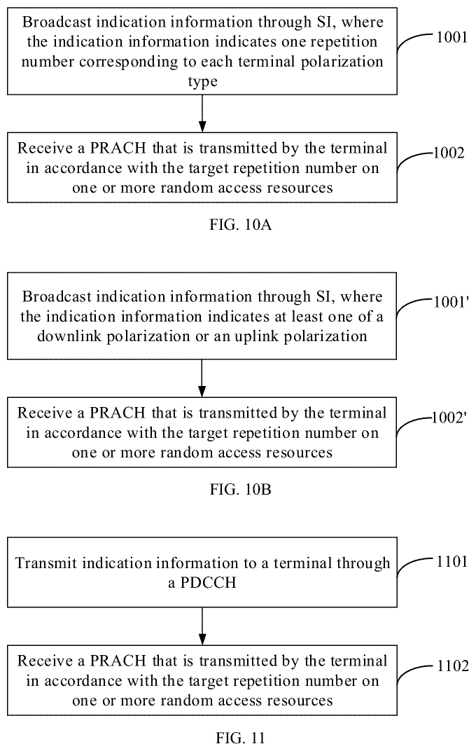

In some alternative or additional examples, as illustrates in FIG. 10A, it illustrates a flowchart of a channel transmission method according to an example. The method may be applied to a base station, which may be a base station in an NTN. The method may include the following steps 1001-1002.

At step 1001, indication information is broadcast through SI, where the indication information indicates one repetition number corresponding to each terminal polarization type.

In the example of the present disclosure, one or more candidate repetition numbers corresponding to each terminal polarization type may be agreed upon by a protocol in advance, for example, as shown in Table 1. Furthermore, the base station may determine one repetition number corresponding to each terminal polarization type, take the one repetition number corresponding to each terminal polarization type as the indication information, and broadcast it through the SI.

At step 1002, a PRACH that is transmitted by the terminal in accordance with the target repetition number is received on one or more random access resources.

In the example of the present disclosure, the terminal has not accessed the base station and is to complete an initial random access procedure based on the SI. The approach for the terminal to determine the target repetition number is similar to the approach illustrated in FIG. 3A, which is not repeated here.

In the example, the indication information may be transmitted to the terminal through the SI, and indicate one repetition number corresponding to each terminal polarization type, so that the terminal can determine the corresponding target repetition number of the PRACH based on the indication information, thereby effectively compensating the terminal that has a polarization loss for the polarization loss, and effectively reducing a terminal power loss for the terminal that has no polarization loss, which has a high availability.

In some alternative or additional examples, as illustrates in FIG. 10B, it illustrates a flowchart of a channel transmission method according to an example. The method may be applied to a base station, which may be a base station in an NTN. The method may include the following steps 1001′-1002′.

At step 1001′, indication information is broadcast through SI, where the indication information indicates at least one of a downlink polarization or an uplink polarization.

In the example of the present disclosure, the downlink polarization refers to the polarization adopted by the base station to transmit downlink signals, while the uplink polarization refers to the polarization adopted to transmit uplink signals, which may be the polarization adopted by the terminal to transmit the uplink signals and expected by the base station.

At step 1002′, a PRACH that is transmitted by the terminal in accordance with the target repetition number is received on one or more random access resources.

In the example of the present disclosure, the terminal has not accessed the base station and is to complete an initial random access procedure based on the SI. The approach for the terminal to determine the target repetition number is similar to the approach illustrated in FIG. 3B, which is not repeated here.

In the example, the indication information may be transmitted to the terminal through the SI, and indicate at least one of the uplink polarization or the downlink polarization, so that the terminal can determine the corresponding target repetition number of the PRACH based on the indication information, thereby effectively compensating the terminal that has a polarization loss for the polarization loss, and effectively reducing a terminal power loss for the terminal that has no polarization loss, which has a high availability.

In some alternative or additional examples, as illustrates in FIG. 11, it illustrates a flowchart of a channel transmission method according to an example. The method may be applied to a base station, which may be a base station in an NTN. The method may include the following steps 1101-1102.

At step 1101, indication information is transmitted to a terminal through a PDCCH.

In the example of the present disclosure, the indication information is used by the terminal to determine a target repetition number corresponding to a polarization adopted by the terminal.

At step 1102, a PRACH that is transmitted by the terminal in accordance with the target repetition number is received on one or more random access resources.

In the example, during a random access procedure triggered based on a PDCCH order, the indication information may be transmitted to the terminal through the PDCCH, so that the terminal can determine the corresponding target repetition number of the PRACH based on the indication information, thereby effectively compensating the terminal that has a polarization loss for the polarization loss, and effectively reducing a terminal power loss for the terminal that has no polarization loss, which has a high availability.

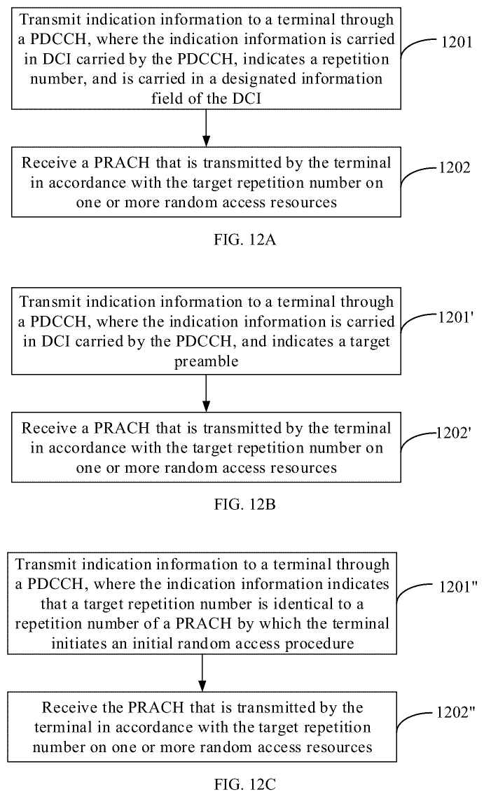

In some alternative or additional examples, as illustrates in FIG. 12A, it illustrates a flowchart of a channel transmission method according to an example. The method may be applied to a base station, which may be a base station in an NTN. The method may include the following steps 1201-1202.

At step 1201, indication information is transmitted to a terminal through a PDCCH, where the indication information is carried in DCI carried by the PDCCH, indicates a repetition number, and is carried in a designated information field of the DCI.

In a possible implementation, the designated information field may be an information field newly added in the DCI, which is specifically configured to indicate the repetition number.

In another possible implementation, the designated information field may reuse an existing information field of the DCI. In some examples, an information field corresponding to a preamble index may be reused.

At step 1202, a PRACH that is transmitted by the terminal in accordance with the target repetition number is received on one or more random access resources.

The approach for the terminal to determine the target repetition number is similar to the approach illustrated in FIG. 5A, which is not repeated here.

In the example, the base station may enable the terminal to determine the target repetition number by means of explicit DCI indication, thereby effectively compensating the terminal that has a polarization loss for the polarization loss, and effectively reducing a terminal power loss for the terminal that has no polarization loss, which has a high availability.

In some alternative or additional examples, as illustrates in FIG. 12B, it illustrates a flowchart of a channel transmission method according to an example. The method may be applied to a base station, which may be a base station in an NTN. The method may include the following steps 1201′-1202′.

At step 1201′, indication information is transmitted to a terminal through a PDCCH, where the indication information is carried in DCI carried by the PDCCH, and indicates a target preamble.

At step 1202′, a PRACH that is transmitted by the terminal in accordance with a target repetition number is received on one or more random access resources.

In a possible implementation, the base station may also transmit RRC signaling to the terminal, where the RRC signaling indicate preamble types to which different preambles belong. The approach that the terminal determines the target repetition number based on the RRC signaling and the target preamble in the DCI is similar to the approach illustrated in FIG. 5B, which is not repeated here.

In the example, the base station may enable the terminal to determine the target repetition number by means of implicit DCI indication, thereby effectively compensating the terminal that has a polarization loss for the polarization loss, and effectively reducing a terminal power loss for the terminal that has no polarization loss, which has a high availability. In some alternative or additional examples, as illustrates in FIG. 12C, it illustrates a flowchart of a channel transmission method according to an example. The method may be applied to a base station, which may be a base station in an NTN. The method may include the following steps 1201″-1202″.

At step 1201″, indication information is transmitted to a terminal through a PDCCH, where the indication information indicates that a target repetition number is identical to a repetition number of a PRACH by which the terminal initiates an initial random access procedure.

At step 1202″, the PRACH that is transmitted by the terminal in accordance with the target repetition number is received on one or more random access resources.

In the example of the present disclosure, the terminal may determine the repetition number of the PRACH during the initial random access procedure in the approach illustrated in FIG. 3A or FIG. 3B, and take the repetition number as the target repetition number for transmitting the PRACH during the random access procedure triggered based on a PDCCH order. The approach for determining the target repetition number in detail is similar to the approach illustrated in FIG. 5C, which is not repeated here.

In the example, based on the indication information in the PDCCH, the base station may enable the terminal to determine the target repetition number for transmitting the PRACH, thereby effectively compensating the terminal that has a polarization loss for the polarization loss, and effectively reducing a terminal power consumption and avoiding a terminal resource waste for the terminal that has no polarization loss, which has a high availability.

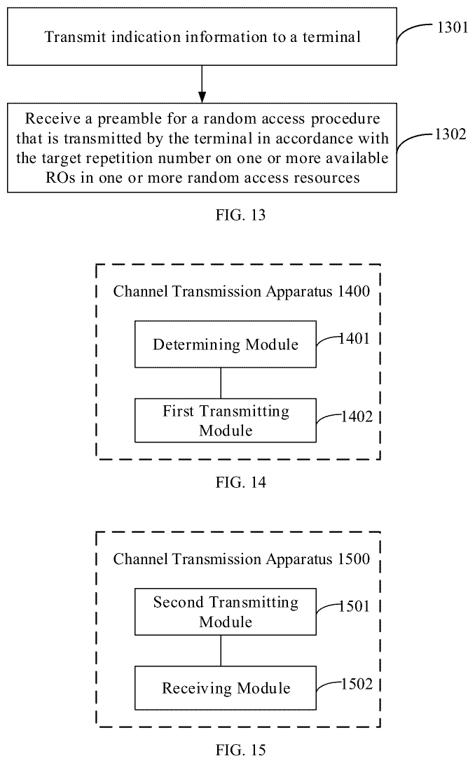

In some alternative or additional examples, as illustrates in FIG. 13, it illustrates a flowchart of a channel transmission method according to an example. The method may be applied to a base station, which may be a base station in an NTN. The method may include the following steps 1301-1302.

At step 1301, indication information is transmitted to a terminal.

In the example of the present disclosure, the indication information is used by the terminal to determine a target repetition number corresponding to a polarization adopted by the terminal.

At step 1302, a preamble for a random access procedure that is transmitted by the terminal in accordance with the target repetition number is received on one or more available ROs in one or more random access resources.

The approach for determining the one or more available ROs is similar to the approach illustrated in FIG. 7A or FIG. 7B, which is not repeated here.

In the example, the base station transmits the indication information to the terminal, and the terminal determines the target repetition number for transmitting the PRACH based on the indication information. Furthermore, the base station receives the preamble transmitted by the terminal to the base station on the available RO(s). Therefore, it can effectively compensate the terminal having a polarization loss for the polarization loss, and effectively reduce a terminal power consumption and avoid a terminal resource waste for the terminal having no polarization loss, which has a high availability.

Corresponding to the described method examples implementing the application functions, the present disclosure further provides apparatus examples implementing the application functions.

Referring to FIG. 14, it illustrates a block diagram of a channel transmission apparatus 1400 according to an example. The apparatus 1400 is applied to a terminal and includes:
a determining module 1401 that is configured to determine, based on indication information transmitted by a base station, a target repetition number corresponding to a polarization adopted by the terminal; and
a first transmitting module 1402 that is configured to transmit, in accordance with the target repetition number, a PRACH on one or more random access resources.

Referring to FIG. 15, it illustrates a block diagram of a channel transmission apparatus 1500 according to an example. The apparatus 1500 is applied to a base station and includes:
a second transmitting module 1501 that is configured to transmit indication information to a terminal, where the indication information is used by the terminal to determine a target repetition number corresponding to a polarization adopted by the terminal; and
a receiving module 1502 that is configured to receive, on one or more random access resources, a PRACH that is transmitted by the terminal in accordance with the target repetition number.

For the apparatus examples, since they basically correspond to the method examples, reference may be made to the partial descriptions of the method examples for related parts. The apparatus examples described above are merely illustrative, in which the units described as separate components may or may not be physically separated, and the components displayed as the units may or may not be physical units, that is, may be located in one place or distributed to a plurality of units in a network. Some or all of the modules may be selected according to actual needs to achieve the purpose of the implementations of the present disclosure. It can be understood and implemented by those of ordinary skill in the art without any creative effort.

Accordingly, the present disclosure also provides a computer-readable storage medium, which stores a computer program. The computer program is configured to perform any one of the described channel transmission methods applicable to the terminal side.

Accordingly, the present disclosure also provides a computer-readable storage medium, which stores a computer program. The computer program is configured to perform any one of the described channel transmission methods applicable to the base station side.

Accordingly, the present disclosure also provides a channel transmission apparatus, including:
one or more processors; and
one or more memories for storing instructions executable by the one or more processors.

The one or more processors are configured to perform any one of the described channel transmission methods at the terminal side.

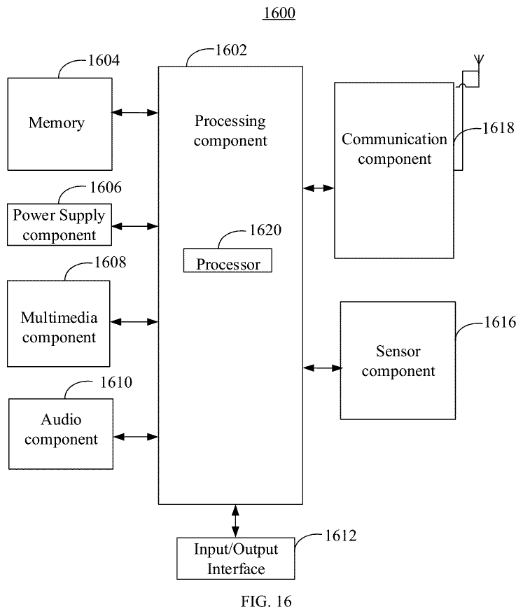

FIG. 16 illustrates a block diagram of a channel transmission apparatus 1600 according to an example. For example, the apparatus 1600 may be a terminal such as a mobile phone, a tablet, an e-book reader, a multimedia player, a wearable device, in-vehicle user equipment, an ipad, a smart TV.

Referring to FIG. 16, the apparatus 1600 may include one or more of the following components: a processing component 1602, a memory 1604, a power supply component 1606, a multimedia component 1608, an audio component 1610, an input/output (I/O) interface 1612, a sensor component 1616, and a communication component 1618.

The processing component 1602 generally controls the overall operations of the apparatus 1600, such as operations associated with display, phone calls, data communications, camera operations, and recording operations. The processing component 1602 may include one or more processors 1620 to execute instructions to complete all or a part of the steps of the described channel transmission methods. In addition, the processing component 1602 may include one or more modules which facilitate the interaction between the processing component 1602 and other components. As an example, the processing component 1602 may include a multimedia module to facilitate the interaction between the multimedia component 1608 and the processing component 1602. As another example, the processing component 1602 may read executable instructions from one or more memories to implement the steps of a channel transmission method provided by each of the described examples.

The memory 1604 is configured to store various types of data to support the operations of the apparatus 1600. Examples of such data include instructions for any application or method operated on the apparatus 1600, contact data, phonebook data, messages, pictures, videos, and the like. The memory 1604 may be implemented by any type of volatile or non-volatile storage device or a combination thereof, such as a static random access memory (SRAM), an electrically erasable programmable read-only memory (EEPROM), an erasable and programmable read-only memory (EPROM), a programmable read-only memory (PROM), a read-only memory (ROM), a magnetic memory, a flash memory, a magnetic disk or an optical disk.

The power supply component 1606 provides power for various components of the apparatus 1600. The power supply component 1606 may include a power management system, one or more power supplies, and other components associated with generating, managing, and distributing power for the apparatus 1600.

The multimedia component 1608 includes a screen providing an output interface between the apparatus 1600 and a user. In some embodiments, the multimedia component 1608 includes a front-facing camera and/or a rear-facing camera. The front camera and/or rear camera may receive external multimedia data when the apparatus 1600 is in an operating mode, such as a photographing mode or a video mode. Each front camera and rear camera may be a fixed optical lens system or have focal length and optical zooming capability.

The audio component 1610 is configured to output and/or input audio signals. For example, the audio component 1610 includes a microphone (MIC) that is configured to receive an external audio signal when the apparatus 1600 is in an operating mode, such as a call mode, a recording mode, and a voice recognition mode. The received audio signal may be further stored in memory 1604 or transmitted via communication component 1618. In some examples, the audio component 1610 also includes a speaker for outputting audio signals.

The I/O interface 1612 provides an interface between the processing component 1602 and a peripheral interface module. The above peripheral interface module may be a keyboard, a click wheel, buttons, or the like. These buttons may include but not limited to a home button, a volume button, a start button and a lock button.

The sensor component 1616 includes one or more sensors to provide the apparatus 1600 with status assessments in various aspects. For example, the sensor component 1616 may detect an open/closed state of the apparatus 1600 and a relative positioning of components such as the display and keypad of the apparatus 1600, and the sensor component 1616 can also detect a change in position of the apparatus 1600 or a component of the apparatus 1600, the presence or absence of user contact with the apparatus 1600, orientation or acceleration/deceleration of the apparatus 1600, and temperature change of the apparatus 1600. The sensor component 1616 may include a proximity sensor configured to detect the presence of a nearby object without any physical contact. The sensor component 1616 may also include a light sensor, such as a complementary metal oxide semiconductor (CMOS) or charge-coupled device (CCD) image sensor, for being applied in imaging applications. In some examples, the sensor component 1616 may also include an acceleration sensor, a gyro sensor, a magnetic sensor, a pressure sensor, or a temperature sensor.

The communication component 1618 is configured to facilitate wired or wireless communication between the apparatus 1600 and other devices. The apparatus 1600 may access a wireless network based on a communication standard, such as Wi-Fi, 2G, 3G, 4G, 5G, 6G, or a combination thereof. In an example, the communication component 1618 receives broadcast signals or broadcast related information from an external broadcast management system via a broadcast channel. In an example, the communication component 1618 also includes a near field communication (NFC) module to facilitate short-range communication. For example, the NFC module may be implemented based on a radio frequency identification (RFID) technology, an infrared data association (IrDA) technology, an ultra-wideband (UWB) technology, a Bluetooth® (BT) technology and other technologies.

In an example, the apparatus 1600 may be implemented by at least one application specific integrated circuit (ASIC), digital signal processor (DSP), digital signal processing device (DSPD), programmable logic device (PLD), field programmable gate array (FPGA), controller, microcontroller, microprocessor, or another electronic component for performing any one of the described channel transmission methods at the terminal side.

In an example, there is also provided a non-transitory computer-readable storage medium including instructions, such as the memory 1604 including instructions. These instructions may be executed by the one or more processors 1620 of the apparatus 1600 to complete the described channel transmission methods. For example, the non-transitory computer-readable storage medium may be ROM, random access memory (RAM), CD-ROM, magnetic tape, floppy disk, optical data storage device, and the like.

Accordingly, the present disclosure also provides a channel transmission apparatus, including:
one or more processors; and
one or more memories for storing instructions executable by the one or more processors.

The one or more processors are configured to perform any one of the described channel transmission methods at the base station side.

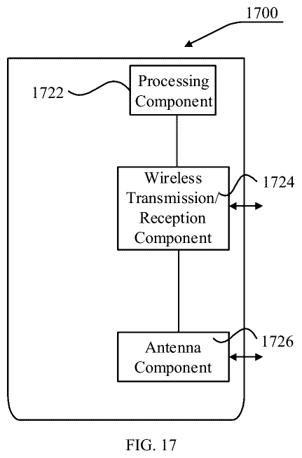

As illustrated in FIG. 17, it illustrates a schematic structural diagram of a channel transmission apparatus 1700 according to an example. The apparatus 1700 may be provided as a base station. Referring to FIG. 17, the apparatus 1700 includes a processing component 1722, a wireless transmission/reception component 1724, an antenna component 1726, and a signal processing part peculiar to a wireless interface. The processing component 1722 may further include at least one processor.

One of the processors in the processing component 1722 may be configured to perform any one of the described channel transmission methods.

Other implementations of the present disclosure will be readily apparent to those skilled in the art after implementing the disclosure by referring to the description. The present disclosure is intended to cover any variations, uses, or adaptations of the present disclosure that are in accordance with the general principles thereof and include common general knowledge or conventional technical means in the art that are not disclosed in the present disclosure. The description and the examples are only illustrative, and the scope and spirit of the present disclosure are to be indicated by appended claims.

It should be understood that the present disclosure is not limited to the above-described accurate structures illustrated in the drawings, and various modifications and changes can be made to the present disclosure without departing from the scope thereof. The scope of the present disclosure is to be limited only by the appended claims.

1. A channel transmission method, performed by a terminal, comprising:
determining, based on indication information transmitted by a base station, a target repetition number corresponding to a polarization adopted by the terminal; and
transmitting, in accordance with the target repetition number, a physical random access channel (PRACH) on one or more random access resources.

2. The method according to claim 1, further comprising:
receiving the indication information that is broadcasted by the base station through system information (SI); or
receiving the indication information that is transmitted by the base station through a physical downlink control channel (PDCCH).

3. The method according to claim 2, wherein when receiving the indication information that is broadcasted by the base station through the SI, the indication information indicates one repetition number corresponding to each terminal polarization type; and
wherein determining, based on the indication information transmitted by the base station, the target repetition number corresponding to the polarization adopted by the terminal comprises:
taking, based on the indication information, a repetition number corresponding to the terminal polarization type adopted by the terminal as the target repetition number.

4. (canceled)

5. The method according to claim 2, wherein when receiving the indication information that is broadcasted by the base station through the SI, the indication information indicates at least one of a downlink polarization or an uplink polarization.

6. The method according to claim 5,
wherein determining, based on the indication information transmitted by the base station, the target repetition number corresponding to the polarization adopted by the terminal comprises:
determining a repetition coefficient based on an indicated uplink polarization and the polarization adopted by the terminal; and
taking a product of the repetition coefficient and a preset transmission number of the PRACH as the target repetition number; and
wherein the method further comprises:
determining that the indicated uplink polarization is identical to an indicated downlink polarization in a case that the indication information indicates only the downlink polarization.

7. The method according to claim 6, wherein determining the repetition coefficient based on the indicated uplink polarization and the polarization adopted by the terminal comprises:
determining the repetition coefficient to be 1 in response to determining that the indicated uplink polarization is identical to the polarization adopted by the terminal; and
determining the repetition coefficient to be 2 in response to determining that the indicated uplink polarization is different from the polarization adopted by the terminal.

8.-9. (canceled)

10. The method according to claim 2, wherein when receiving the indication information that is transmitted by the base station through the PDCCH, the indication information is carried in downlink control information (DCI) carried by the PDCCH.

11. The method according to claim 10,
wherein the indication information indicates a repetition number; and
wherein determining, based on the indication information, the target repetition number corresponding to the polarization adopted by the terminal comprises:
determining the target repetition number based on a value indicated in a designated information field of the DCI;
wherein the designated information field is an information field configured to indicate the repetition number in the DCI, or the designated information field reuses an information field corresponding to a preamble index.

12. (canceled)

13. The method according to claim 10,
wherein the indication information indicates a target preamble;
wherein determining, based on the indication information, the target repetition number corresponding to the polarization adopted by the terminal comprises:
determining, based on preamble types to which different preambles belong, a target preamble type to which the target preamble belongs; and
taking, based on a predefined correspondence between the preamble types and repetition numbers, a repetition number corresponding to the target preamble type as the target repetition number; and
wherein the method further comprises:
receiving radio resource control (RRC) signaling transmitted by the base station, wherein the RRC signaling indicates the preamble types to which the different preambles belong.

14. (canceled)

15. The method according to claim 2, wherein when receiving the indication information that is transmitted by the base station through the PDCCH, the indication information indicates that the target repetition number is identical to a repetition number of the PRACH by which the terminal initiates an initial random access procedure.

16. The method according to claim 1, wherein transmitting, in accordance with the target repetition number, the PRACH on the one or more random access resources comprises:
transmitting, in accordance with the target repetition number, a preamble for a random access procedure on one or more available PRACH occasions (ROs) in the one or more random access resources.

17. A channel transmission method, performed by a base station, comprising:
transmitting indication information to a terminal, wherein the indication information is used by the terminal to determine a target repetition number corresponding to a polarization adopted by the terminal; and
receiving, on one or more random access resources, a physical random access channel (PRACH) that is transmitted by the terminal in accordance with the target repetition number.

18. The method according to claim 17, wherein transmitting the indication information to the terminal comprises:
broadcasting the indication information through system information (SI); or
transmitting the indication information to the terminal through a physical downlink control channel (PDCCH).

19. The method according to claim 18, wherein when broadcasting the indication information through the SI,
the indication information indicates one repetition number corresponding to each terminal polarization type, and the method further comprises: determining, from one or more candidate repetition numbers corresponding to each terminal polarization type agreed upon by a protocol, the one repetition number corresponding to each terminal polarization type to be transmitted to the terminal; or
the indication information indicates at least one of a downlink polarization or an uplink polarization.

20.-22. (canceled)

23. The method according to claim 18, wherein when transmitting the indication information to the terminal through the PDCCH, the indication information is carried in downlink control information (DCI) carried by the PDCCH.

24. The method according to claim 23,
wherein the indication information indicates a repetition number, and the indication information is carried in a designated information field of the DCI, wherein the designated information field is an information field configured to indicate the repetition number in the DCI, or the designated information field reuses an information field corresponding to a preamble index; or
wherein the indication information indicates a target preamble, and the method further comprises:
transmitting radio resource control (RRC) signaling to the terminal, wherein the RRC signaling indicates preamble types to which different preambles belong.

25.-27. (canceled)

28. The method according to claim 18, wherein when transmitting the indication information to the terminal through the PDCCH, the indication information indicates that the target repetition number is identical to a repetition number of the PRACH by which the terminal initiates an initial random access procedure.

29. The method according to claim 17, wherein receiving, on the one or more random access resources, the PRACH that is transmitted by the terminal in accordance with the target repetition number comprises:
receiving, on one or more available PRACH occasions (ROs) in the one or more random access resources, a preamble for a random access procedure that is transmitted by the terminal in accordance with the target repetition number.

30.-33. (canceled)

34. A channel transmission apparatus, comprising:
one or more processors; and
one or more memories for storing instructions executable by the one or more processors;
wherein the one or more processors are configured to:
determine, based on indication information transmitted by a base station, a target repetition number corresponding to a polarization adopted by the terminal; and
transmit, in accordance with the target repetition number, a physical random access channel (PRACH) on one or more random access resources.

35. A channel transmission apparatus, comprising:
one or more processors; and
one or more memories for storing instructions executable by the one or more processors;
wherein the one or more processors are configured to perform the channel transmission method according to claim 17.
